(19) United States
(12) Patent Application Publication
(10) Pub. No.: US 2020/0410368 A1
(43) Pub. Date: Dec. 31, 2020

(54) EXTENDED RULE GENERATION

(71) Applicant: International Business Machines Corporation, Armonk, NY (US)

(72) Inventors: Yuhko Kanoh Hasegawa, Tokyo (JP); Mari Abe Fukuda, Tokyo (JP)

(21) Appl. No.: 16/451,201

(22) Filed: Jun. 25, 2019

(51) Int. Cl. G06N 5/02; G07C 5/08; G07C 5/00

(52) U.S. Cl. CPC G06N 5/025; G07C 5/008; G07C 5/085; G07C 5/0816

(57) ABSTRACT

Provided is a method, computer program product, and system for generating extended rules from common rules for vehicles. A processor may receive real-time data from one or more internet of things (IoT) devices that are communicatively coupled to a vehicle. The processor may analyze the real-time data by applying one or more event detection rules. The processor may determine that the one or more event detection rules have not been met. The processor may extract contextual data from the real-time data. The processor may correlate the contextual data with the one or more event detection rules. The processor may generate, in response to the correlating, one or more extended rules incorporating the contextual data. The processor may apply the one or more generated extended rules to the real-time data.

### BACKGROUND

The present disclosure relates generally to the field of automobiles, and more specifically, to generating extended rules from common event detection rules for informing a driver of a vehicle related event.

Event detection rules (e.g., common rules) may be applied to various types of real-time data to determine actions for informing a driver of an event (e.g., potential danger). The event detection rules may be created by analyzing historical vehicle data from multiple vehicle data sources and generating rules based on the data. The event detection rules may be incorporated into a vehicle system to warn a driver of danger when various events are detected.

### SUMMARY

Embodiments of the present disclosure include a method and system for generating extended rules from common event detection rules for vehicles. A processor may receive real-time data from one or more internet of things (IoT) devices that are communicatively coupled to a vehicle. The processor may analyze the real-time data by applying one or more event detection rules. The processor may determine that the one or more event detection rules have not been met. The processor may extract contextual data from the real-time data. The processor may correlate the contextual data with the one or more event detection rules. The processor may generate, in response to the correlating, one or more extended rules incorporating the contextual data. The processor may apply the one or more extended rules to the real-time data.

Additional embodiments include a computer program product for generating extended rules from common event detection rules for vehicles. A processor may receive real-time data from one or more internet of things (IoT) devices that are communicatively coupled to a vehicle. The processor may extract contextual data from the real-time data. The processor may correlate the contextual data with one or more event detection rules. The processor may generate, in response to the correlating, one or more extended rules incorporating the contextual data. The processor may apply the one or more extended rules to the real-time data. The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a block diagram of an example system architecture, in accordance with embodiments of the present disclosure.

FIG. 2 illustrates a flow diagram of an example process for generating an extended rule, in accordance with embodiments of the present disclosure.

FIG. 3 illustrates a flow diagram of an example process for performing an action in response to an extended rule being met, in accordance with embodiments of the present disclosure.

FIG. 4A illustrates an example common event detection rule, in accordance with embodiments of the present disclosure.

FIG. 4B illustrates an example extended rule incorporated into a common event detection rule, in accordance with embodiments of the present disclosure.

FIG. 5 illustrates a high-level block diagram of an example computer system that may be used in implementing one or more of the methods, tools, and modules, and any related functions, described herein, in accordance with embodiments of the present disclosure.

FIG. 6 depicts a cloud computing environment according to an embodiment of the present invention.

FIG. 7 depicts abstraction model layers according to an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate to the field of automobiles, and more particularly to generating extended rules from common event detection rules for informing a driver of a vehicle related event. While the present disclosure is not necessarily limited to such applications, various aspects of the disclosure may be appreciated through a discussion of various examples using this context.

Event detection rules (e.g., common rules) may be applied to various types of real-time data to determine actions for informing a driver of a vehicle related event (e.g., potential danger). The common event detection rules may be created by analyzing historical vehicle data from multiple vehicle data sources. Based on the analyzed historical vehicle data, the event detection rules may be incorporated into a vehicle monitoring system to warn a driver of danger when various events are detected. The vehicle monitoring system may receive data from various sources, such as one or more internet of things (IoT) devices (e.g., user devices, onboard vehicle device, etc.) that are linked to the vehicle. If the event detection rule is met when applying the rule to the real-time data, the system may generate an event and notify the driver.

In many instances, common event detection rules do not account for contextual data that may be available when analyzing whether an event occurred. For example, many event detection rules are common to all drivers and vehicles such that specific driver information (e.g., user profile, driver behavioral history, biometric state, etc.) and/or vehicle information (e.g., vehicle weight, tire condition, etc.) may not affect whether the rule is executed.

For example, a common event detection rule for aquaplaning may not account for various weights and/or tire configurations of the specific vehicle and may be applied broadly to all vehicles traveling at a certain speed. However, a lighter vehicle that may be more susceptible to aquaplaning at certain speeds may not be alerted based on a broadly applied common rule.

In another example, the common event detection rule for traveling in a wrong direction on a highway ramp may not account for the specific driver's behavioral history (e.g., past occurrences of driving in the wrong direction) and may fail to warn the driver prior to entering the highway ramp in the wrong direction. In many instances, dangerous events may occur that do not meet the common event detection rule threshold and therefore the event may be overlooked.

Embodiments of the present disclosure generate extended rules from common event detection rules by utilizing contextual data to inform a driver of potentially dangerous events that may be overlooked. In embodiments, the system may receive real-time data from one or more internet of things (IoT) devices that are communicatively coupled to a vehicle.

For example, the system may receive data from both a vehicle device (e.g., onboard computing system linked to various vehicle sensors) and a communicatively coupled user device (e.g., smartphone). In embodiments, the system may analyze the real-time data by applying one or more event detection rules. For example, the system may analyze various vehicle sensor data to determine if a slippery road event occurred.

In embodiments, if the system has determined no event has occurred by applying the common event detection rules to the data, the system may extract contextual data from the real-time data. The system may extract various contextual data to determine if an extended rule may be generated from the common event detection rule. For example, the system may extract the driver's behavioral history, the user's demographic information, and/or various aspects related to the vehicle (e.g., weight, tire tread wear, tire pressure, maintenance history, etc.) that may not have been included when analyzing the common event detection rules. In embodiments, the system may extract the contextual data from the real-time data and generate the extended rule without determining if one or more common event detection rules have been executed. In this way, the system may only need to analyze the contextual data to generate one or more extended rules.

In embodiments, the system may correlate the contextual data with the one or more event detection rules and generate one or more extended rules incorporating the contextual data. Once the system has generated the one or more extended rules, the system may apply the one or more extended rules to the real-time data.

For example, the system may utilize the driver's demographic information and driver behavioral history to modify the common rule for notifying a user when data indicates that they are both traveling in the wrong direction and at a highway entrance ramp. The extended rule may be generated to only require that the user is near the exit ramp if the specific user meets a certain extended rule threshold (e.g., previous driver behavior indicating incorrect travel on roadways). In this way, a driver that has a history of driving in the wrong direction may be notified when in proximity to an entrance ramp rather than when the driver is actually driving in the wrong direction. Further, the narrowly applied extended rule prevents other drivers (e.g., drivers not meeting the threshold) from being notified when there is no danger of them driving in the wrong direction.

In embodiments, the extended rules may be applied to various common event detection rules. For example, a common event detection rule may notify a driver that there is a risk of aquaplaning when water is detected on the road (e.g., using vehicle sensors and/or weather data) and the vehicle is traveling faster than a certain speed (e.g., 50 mph or greater). This common rule may be broadly applied to all vehicles. However, a lighter vehicle may be susceptible to aquaplaning at lower speeds, but this event may be overlooked because the common event detection rule has a higher speed threshold for warning the driver. In embodiments, the system may extract contextual data relative to the weight/type of vehicle and generate an extended rule that may display an aquaplaning warning if both the vehicle is traveling at a certain speed (e.g., 30 mph or greater) and the vehicle's weight is at a certain amount (e.g., less than 2000 lbs.). This allows the aquaplaning rule to be applied narrowly based on the extracted contextual data and prevents warning other vehicles unnecessarily.

In embodiments, if the one or more extended rules have been met, the system may perform an action. For example, the system may activate/deactivate one or more systems/components of the vehicle. For example, the system may activate vehicle stability assist for a larger vehicle when entering a specific curvy roadway based on contextual data (e.g., data indicating the large vehicle has difficulty navigating curves/turns) taken from the real-time data.

In another example, the system may display a notification on an onboard vehicle device or send a notification to one or more linked IoT devices in response to the extended rule being met. For example, based on contextual data regarding a specific user, the system may warn the respective user of a dangerous event via the vehicles onboard display. In another example, the system may send a notification to one or more other users to warn the them that the specific driver of the vehicle has experienced a potentially dangerous event.

The aforementioned advantages are example advantages, and not all advantages are discussed. Furthermore, embodiments of the present disclosure can exist that contain all, some, or none of the aforementioned advantages while remaining within the spirit and scope of the present disclosure.

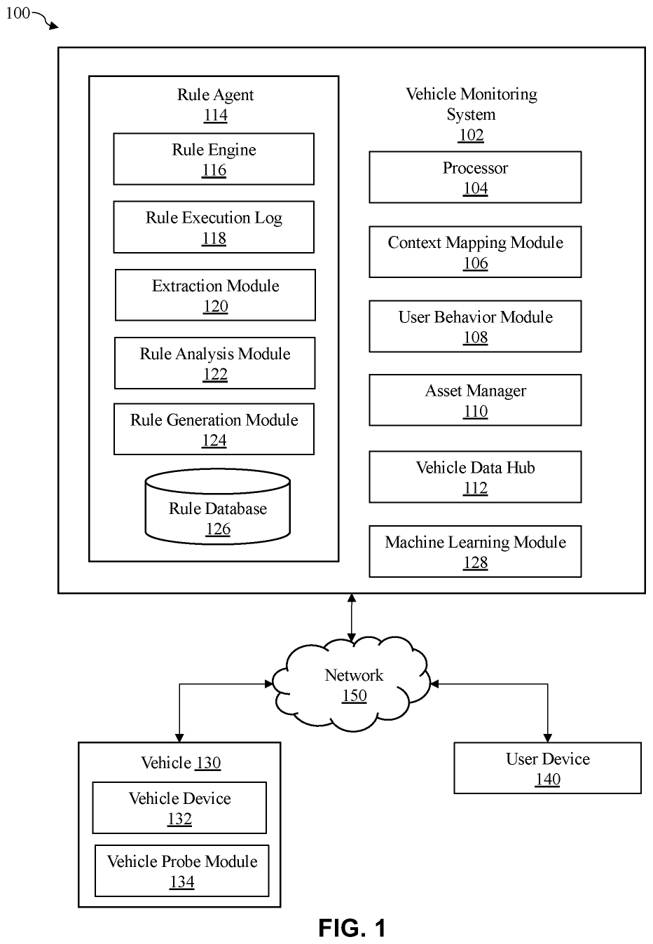

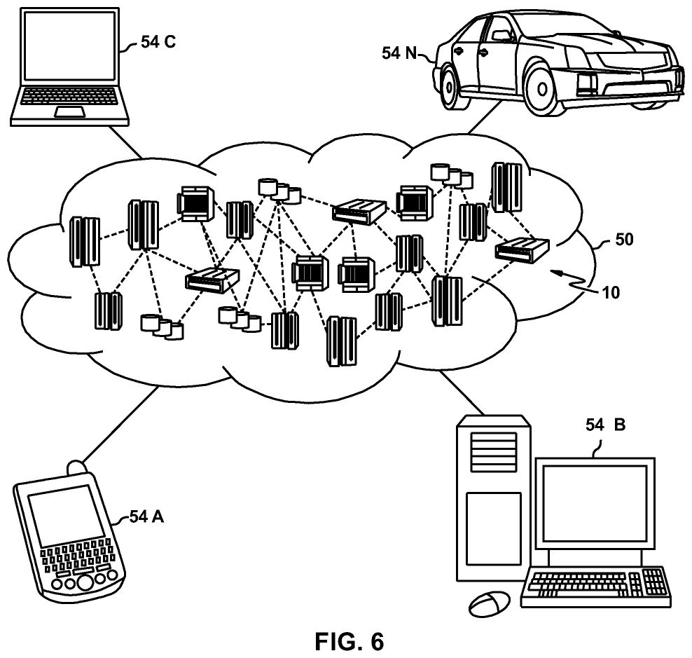

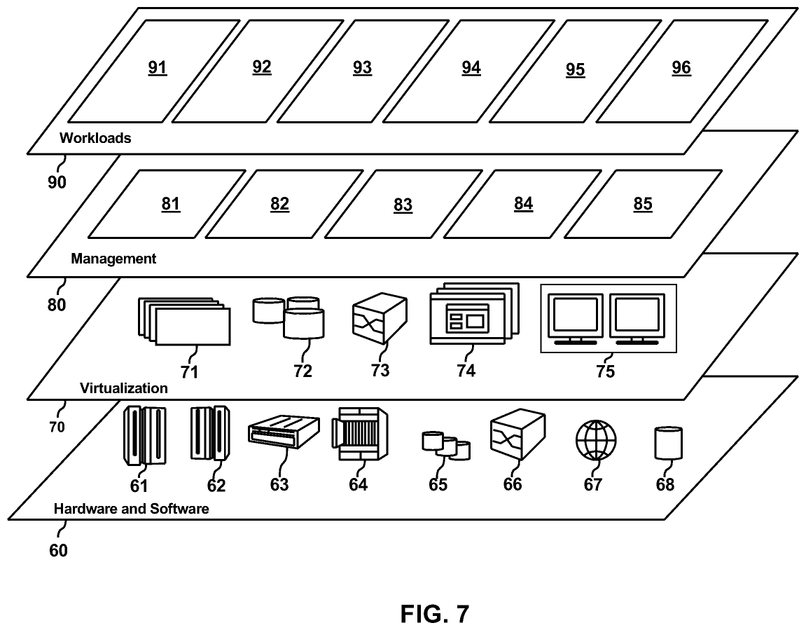

With reference now to FIG. 1, shown is a block diagram of an example system architecture 100, in accordance with embodiments of the present disclosure. In the illustrated embodiment, system architecture 100 includes vehicle monitoring system 102, vehicle 130 include vehicle device 132, and user device 140 that are communicatively coupled via a network 150. The network 150 may be any type of communication network, such as a wireless network or a cloud computing network. The network 150 may be substantially similar to, or the same as, cloud computing environment 50 described in FIG. 6 and FIG. 7.

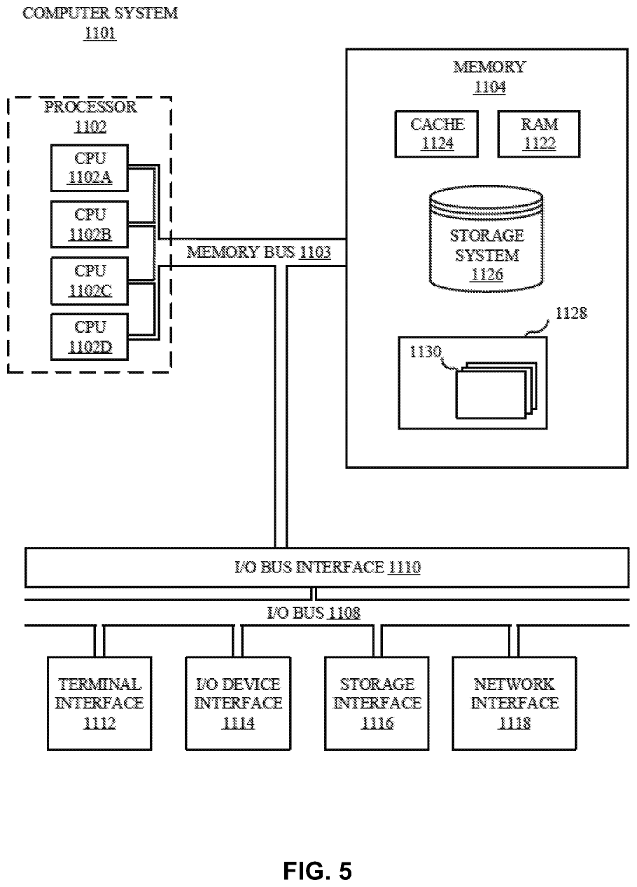

Vehicle 130 may be any type of mobile vehicle (e.g., car, truck, airplane, motorcycle, etc.). Vehicle monitoring system 102, vehicle device 132, and user device 140 may be any type of computer system and may be substantially similar to computer system 1101 detailed in FIG. 5. In embodiments, vehicle device 132 may be a computer system located in vehicle 130 configured to send and receive data to the vehicle monitoring system 102. The vehicle device 132 may be communicatively coupled to vehicle probe module 134. Vehicle probe module 134 may monitor data received from one or more sensors and/or probes that are disposed on the vehicle. For example, vehicle probe module 134 may receive data from various sensors/probes indicating the speed of the vehicle, traction of the tires, tire pressure, and/or temperature of the respective environment. In embodiments, the vehicle probe module 134 may receive data indicating various components of the vehicle are activated (e.g., antilock braking system (ABS), dynamic stability control, etc.).

In embodiments, user device 140 may be any type of computing device (e.g., smartphone, tablet, computer, IoT device, etc.) configured to send and receive various data (e.g., user profile data, motion data, location data, biometric data, etc.) to/from vehicle monitoring system 102 and/or vehicle device 132. User device 140 may be utilized to send/receive various profile information from a user to the vehicle monitoring system 102. For example, a user may input various profile information (e.g., driving experience, health information, demographic information, etc.) that may be uploaded from the user device 140 to the vehicle monitoring system 102. This profile information may be used by the vehicle monitoring system 102 to create a driver profile.

In embodiments, any personal health information and/or any associated personal data may only be collected with the user's informed consent as part of an opt in process. Any health/personal data that is collected will be anonymized and/or encrypted to ensure data security and privacy. Further, a user may opt out from having their personal data collected, at which point any personal data regarding the user will be deleted. In embodiments, the user profile information may be used by user behavior module 108.

User device 140 may be configured to access information regarding the vehicle 130 via the vehicle monitoring system 102 and/or the vehicle device 132. For example, a user may utilize an application on user device 140 to communicate with vehicle monitoring system 102 to track various aspects of the vehicle. For example, a user may track if the vehicle has exceeded any speed limits, if a driver has forcefully applied the brakes, and/or the location of the vehicle during a current driving session.

In embodiments, vehicle monitoring system 102 includes processor 104, context mapping module 106, user behavior module 108, asset manager 110, vehicle data hub 112, and rule agent 114. In embodiments, context mapping module 106 is configured to map various road networks and dynamics (e.g., traffic patterns, accidents, road closures, etc.), route searches, and/or map matching relative to vehicle 130 or vehicle device 132. For example, the context mapping module 106 may add contextual information to a route map based on a vehicle's location relative to various spots on the map. The system may add context such as high accident areas, high traffic areas, and/or various weather-related events (e.g., flooding, slick roads, etc.).

In embodiments, user behavior module 108 is configured to monitor user behavior (e.g., driver behavior) in relation to operating vehicle 130. For example, the user behavior module 108 may monitor various actions performed by a driver of a car through the vehicle's on-board computer (e.g., vehicle device 132) and/or the user's mobile device (e.g., user device 140).

In embodiments, user behavior module 108 may perform driver behavior analysis and/or trajectory pattern analysis for the vehicle 130 to determine a user behavior profile. For example, the user behavior module 108 may analyze that the user has surpassed the speed limit in various areas (e.g., through geo-tracking), forcefully applied the car's brakes, and has performed multiple sharp turns during a driving session. The user behavior module 108 may determine each driver's score based on the actions taken by the user during a driving session. In embodiments, user behavior module 108 may determine driver fatigue based on various sensors and/or cameras that are communicatively coupled to the vehicle device 132 and/or user device 140. For example, the user behavior module 108 may determine a user is fatigued based on facial recognition cues when analyzing images of the driver from a linked IoT camera.

In embodiments, asset manager 110 is configured to manage any data generated by the system 100. Asset manager 110 may be utilized to manage vehicle data, driver information, mapping data, event data, rule generation and execution data, and vendor information. Vehicle data hub 112 is configured to perform various authentication and/or decoding/encoding between the vehicle monitoring system 102 and vehicle 130 and user device 140. For example, the vehicle data hub 112 may perform message queuing telemetry transport (MQTT) between user device 140 and the vehicle monitoring system 102. In another example, vehicle data hub 112 may communicate with vehicle 130 and/or vehicle device 132 using a representational state transfer application program interface (REST API) that uses hypertext transfer protocol (HTTP) methods.

In embodiments, rule agent 114 is configured to detect real-time events that occur relative to vehicle 130. Rule agent 114 may be any type of rule agent. For example, rule agent 114 may be configured as a driver agent, environment agent, and/or vehicle agent that applies various rules to various sets of data. For example, a driver agent may apply a driver related event detection rule to biometric data received from user device 140 to determine a driver is fatigued, while a vehicle agent may apply various road condition event detection rules to data received from various vehicle sensors disposed on the vehicle.

In embodiments, rule agent 114 includes rule engine 116, rule execution log 118, extraction module 120, rule analysis module 122, rule generation module 124, and rule database 126. Rule engine 116 is configured to execute one or more rules in response to any received data meeting a rule threshold. For example, rule agent 114 will send a message notification to vehicle device 132 if rule engine 116 has executed a rule in response to received data indicating the vehicle 130 is traveling in a wrong direction (e.g., based on vehicle motion/location and mapping data). Rule execution log 118 will record any rules that have been executed by the rule engine 116. For example, rule execution log 118 will record any event detection rules that have been executed in response to a report of a potentially dangerous event. For example, vehicle monitoring system 102 may receive data indicating one or more vehicles have generated a slippery road event at a certain location.

Extraction module 120 is configured to analyze contextual data taken from the real-time data generated from vehicle monitoring system 102, vehicle 130, and/or user device 140. In embodiments, extraction module 120 may analyze data received from vehicle probe module 134. For example, the extraction module 120 may analyze weather, road, and/or sensor data received from vehicle probe module 134. The extraction module 120 may utilize the data received from vehicle 130 in order to extract characteristics related to the vehicle, driver, and/or geographical location. For example, the extraction module 120 may determine from the vehicle probe module 134 tire groove information, air pressure information, etc. In another example, extraction module 120 may analyze data generated from user device 140 such as driver profile information, driver history, and/or location information. In some embodiments, extraction module 120 may utilize data received from an internet service (e.g., weather data, traffic data, etc.).

Rule analysis module 122 is configured to analyze common event detection rules with respect to the extracted contextual data. For example, the rule analysis module 122 may determine aspects of the extracted contextual data may be incorporated into a common event detection rule to generate an extended rule.

For example, extracted contextual data may indicate that a driver has a history of driving the wrong direction on roads. A common rule for sending a message to the vehicle to notify a driver that they are traveling in the wrong direction at a highway ramp may be met if real-time data indicates the driver is both at the highway ramp and determined to be driving in the wrong direction based on location data. However, the rule analysis module 122 may determine that the driver's propensity for driving the wrong way may be incorporated into the common event detection rule. For example, the system may notify the driver if the driver is at the highway ramp and traveling in the wrong direction, or if the user is at the highway ramp and has a history of driving the wrong way. In this way, the system may notify drivers based on their specific contextual data (e.g., driver profile) rather than notifying all drivers (common rule) that meet the criteria.

In embodiments, the rule analysis module 122 may determine if various characteristic of the contextual data may be incorporated into a common rule. If the common rule can be extended using the extracted data, as determined by the rule analysis module 122, an extended rule may be generated by rule generation module 124. The common event detection rules and any extended rules generated by the rule generation module 124 may be stored on rule database 126.

In embodiments, vehicle monitoring system 102 may include machine learning module 128. Machine learning module 128 may be any type of cognitive learning engine and/or learning module that includes various algorithms (e.g., supervised, unsupervised, semi-supervised, and/or reinforcement learning algorithms) for analyzing extended rules generated by system 100. For example, the vehicle monitoring system 102 may use machine learning module 128 to analyze historical data for accuracy of extending various rules based on the contextual data received for specific drivers of vehicle 130. The machine learning module 128 may correlate historical extended rule execution to determine the frequency/occurrence of the extended rule based on the real-time data. As more data is learned by the vehicle monitoring system 102, the weights of the rules can be adjusted, automatically, by processor 104. Over time, the system 100 can become more accurate at generating extended rules and/or adjusting extended rule thresholds to accurately warn drivers of potentially dangerous events.

It is noted that FIG. 1 is intended to depict the representative major components of system architecture 100. In some embodiments, however, individual components may have greater or lesser complexity than as represented in FIG. 1, components other than or in addition to those shown in FIG. 1 may be present, and the number, type, and configuration of such components may vary. Likewise, one or more components shown with system architecture 100 may not be present, and the arrangement of components may vary.

For example, while FIG. 1 illustrates an example system architecture 100 having a single vehicle monitoring system 102, a single vehicle 130, and a single user device 140, suitable network architectures for implementing embodiments of this disclosure may include any number of vehicle monitoring systems, vehicles, and user devices. The various models, modules, systems, and components illustrated in FIG. 1 may exist, if at all, across a plurality of vehicle monitoring systems, vehicles, and user devices.

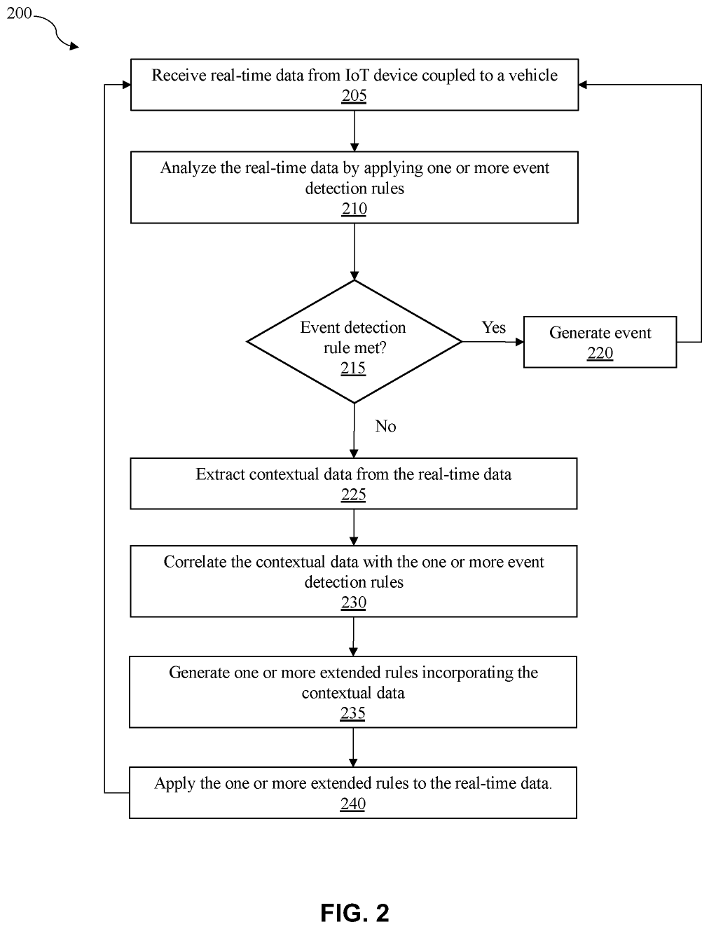

Referring now to FIG. 2, shown is a flow diagram of an example process 200 for generating an extended rule, in accordance with embodiments of the present disclosure. The process 200 may be performed by processing logic that comprises hardware (e.g., circuitry, dedicated logic, programmable logic, microcode, etc.), software (e.g., instructions run on a processor to perform hardware simulation), firmware, or a combination thereof. In some embodiments, the process 200 is a computer-implemented process. The process 200 may be performed by processor 104 exemplified in FIG. 1.

The process 200 begins by receiving real-time data from one or more internet of things (IoT) devices that are communicatively coupled to a vehicle. This is illustrated at step 205. In embodiments, the one or more IoT devices may be any type of device configured to send real-time data regarding the vehicle and/or driver to the vehicle monitoring system 102. For example, the one or more IoT devices may include an onboard vehicle device that is installed in the vehicle and a mobile user device (e.g., smartphone). In other embodiments, the IoT device may be a smartband that sends biometric data relative to the driver to the vehicle and/or vehicle monitoring system 102.

The process 200 continues by analyzing the real-time data by applying one or more event detection rules. This is illustrated at step 210. The event detection rule may be any type of common rule that may generate an event notification related to the vehicle. For example, the common rule may send a notification that a sharp turn is ahead based on location data of the vehicle. In another embodiment, the common rule may send a notification to the driver that vehicle traction control has been activated on the vehicle based on prior events generated from one or more other vehicles proceeding on the same roadway.

The process 200 continues by determining if the one or more event detection rules have been met. This is illustrated at step 215. If the one or more event detection rules have been met, “Yes” at step 215, the process 200 continues by generating an event or event notification. This is illustrated at step 220. The event/event notification may be any type of event (e.g., slippery road event, ABS brakes activated, low tire pressure notification, etc.) related to the activity of the vehicle. Once the event has been generated, the system may continue to monitor real-time data at step 205 to determine if additional common event detection rules have been met.

If the one or more event detection rules have not been met, “No” at step 215, the process 200 continues by extracting contextual data from the real-time data. This is illustrated at step 225. Contextual data may be any type of data that indicates the current condition of the vehicle, the driver, and/or other drivers/vehicles on the road relative to the current driving session.

For example, contextual data may include vehicle sensor data (e.g., tire pressure, traction control, tire grove data, speed, braking, etc.), imaging data (e.g., facial images of the driver, road conditions, etc.), user data, driving behavioral data, temporal data, vehicle data received from one or more other vehicles, vehicle historical data, road condition data (e.g., road having higher wrong way traffic accidents due to confusing layout and/or signage), and weather data. In embodiments, the system may receive various data, such as road condition data and weather condition data, from an internet service (e.g., weather updates, traffic patterns, etc.). The extracted contextual data may be used to determine different extended rules for different users and/or vehicles.

For example, a driver that has a poor driving history during icy conditions may be notified about current conditions based on the weather data and the driver behavioral data. Alternatively, drivers with excellent driving history during icy conditions may not be notified unless a common event detection rule has been met (e.g., slippery road event).

In some embodiments, user data may include biometric data received from one or more user devices (e.g., smartphone, smartwatch, smartband, etc.) that are communicatively coupled to the vehicle device. The biometric data may indicate various conditions of the current driver that may be used as contextual data for creating an extended rule. For example, a driver's heart rate (e.g., as monitored by a smartwatch) may be low indicating a driver is tired and/or falling asleep. In embodiments, the system may correlate this contextual information with the driver's history to create an extended rule to notify this specific driver when their heart rate falls within a certain threshold. In this way, a driver with a history of accidents (e.g., determined from driver behavior) occurring when their heart rate is low (e.g., drowsy driving) may be warned when their heart rate has fallen within this range. In embodiments, the vehicle monitoring system 102 may utilize a communicatively coupled camera to detect a decrease in the user's attention while driving by analyzing facial posture or the state of the driver's eyelids while the heartbeat is low. This contextual data may be utilized to create extended rules based on image recognition cues being met.

In embodiments, if there is no contextual data to be extracted from the real-time data, the system may request modification to the one or more event detection rules. For example, the system may determine various thresholds for the event detection rules (e.g., common rules) are set too low by analyzing various patterns and/or historical data and determining the common rule has not been executed on a consistent basis. In this way, the system may continually assess if the event detection rules are too stringent or lax.

The process 200 continues by correlating the contextual data with the one or more event detection rules. This is illustrated at step 230. In embodiments, the system will incorporate the extracted contextual data into the common rule where appropriate to generate the extended rule. For example, a common rule that may be affected by the driver's behavioral history may include thresholds relative to the behavior (e.g., driver having a history of driving in the wrong direction may include a threshold to warn the driver to proceed with caution at a highway entrance/exit ramp via the vehicles location).

The process 200 continues by generating, in response to the correlating, one or more extended rules incorporating the contextual data. This is illustrated at step 235. In embodiments, the extended rule may include one or more data thresholds incorporating the contextual data. Once the extended rules are generated, the process 200 continues by applying the one or more extended rules to the real-time data. This is illustrated at step 240. For example, the system may compare the real-time data received from the vehicle device to one or more data thresholds of the extended rules.

In some embodiments, one or more operations of process 200 may not be performed. For example, in some embodiments, the process may extract contextual data from the real-time data to generate and apply the one or more extended rules (i.e., perform steps 225-240) without first comparing the real-time data to the common event detection rules (i.e., without performing steps 210 and 215).

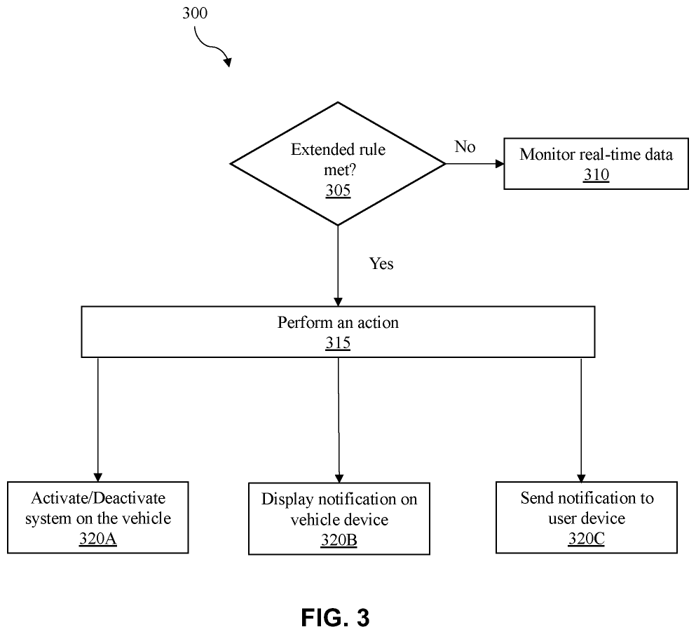

FIG. 3 illustrates a flow diagram of an example process for performing an action in response to an extended rule being met, in accordance with embodiments of the present disclosure. Process 300 may be in addition to or a subset of process 200. The process 300 may be performed by processing logic that comprises hardware (e.g., circuitry, dedicated logic, programmable logic, microcode, etc.), software (e.g., instructions run on a processor to perform hardware simulation), firmware, or a combination thereof. In some embodiments, the process 300 is a computer-implemented process. The process 300 may be performed by processor 104 exemplified in FIG. 1.

The process 300 begins by determining if the one or more extended rule have been met. This is illustrated at step 305. Step 305 may be performed subsequently to step 240 of process 200. If the real-time data does not meet an extended rule (e.g., meeting an extended rule data threshold), “No” at step 305, then the process 300 continues by continuing to monitor real-time data received from the one or more IoT devices. This is illustrated at step 310. If the real-time data does meet the extended rule, “Yes” at step 305, the process 300 continues by performing an action. This is illustrated at step 315.

In embodiments, the action may be any type of action that may assist the driver of the vehicle with decision making related to the detected event. For example, the action performed (at step 315) may include activating or deactivating a system/component on the vehicle. This is illustrated at step 320A. For example, the extended rule may require traction control to be activated for a vehicle determined to be a certain weight when approaching a certain location as determined from the contextual data and previous behavioral history of the driver and/or vehicle history.

In another embodiment, the action performed may include displaying a notification on an onboard vehicle device/display warning the driver of a potentially dangerous event. This is illustrated at step 320B. For example, an extended rule may include generating a display notification for a driver who has a history of accidents related to sharp turns. The system may display a warning on the vehicle's device that a sharp turn is ahead for this specific driver while other drivers may not be notified unless a common rule is met.

In another embodiment, the action performed may include sending a notification to an IoT device (e.g., user device 140) to notify one or more other users of an event occurring relative to the vehicle. This is illustrated at step 320C. For example, one or more users may be notified when a specific driver (e.g., drowsy driver, a driver with a bad driving record, etc.) has exceeded a certain speed limit or has traveled in an incorrect direction on a roadway. The extended rule allows the system to determine specific rules relative to the respective driver and/or vehicle.

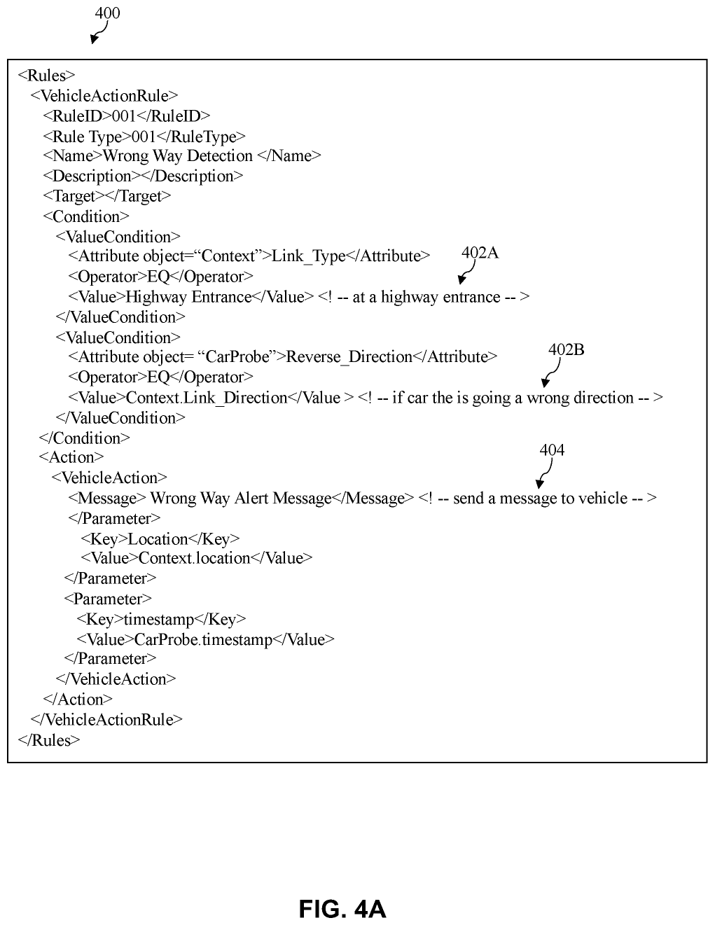

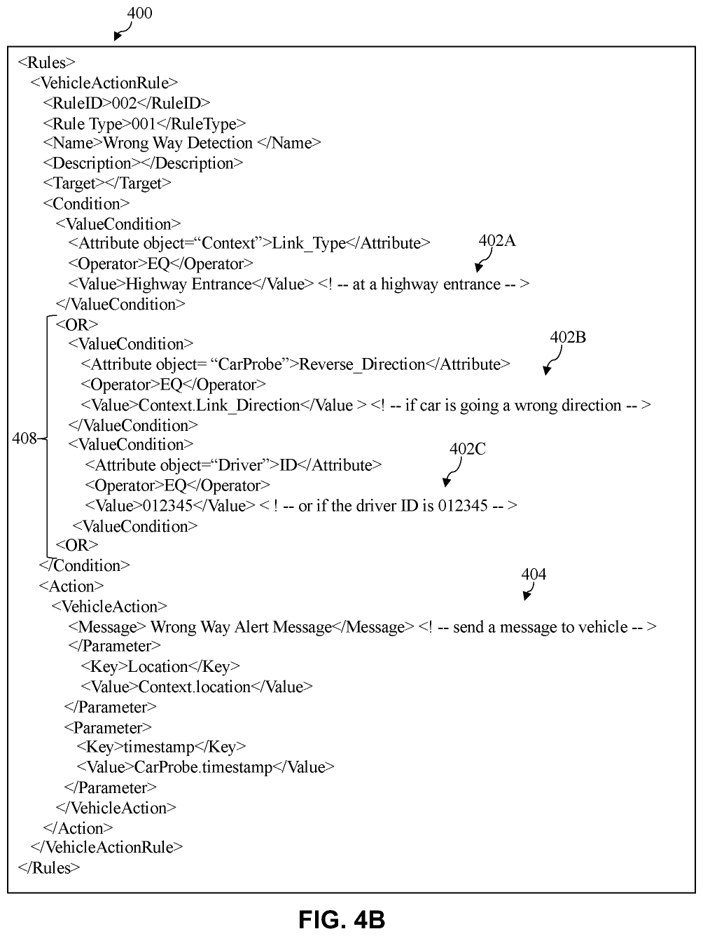

FIG. 4A illustrates an example common event detection rule 400, in accordance with embodiments of the present disclosure. In the illustrated embodiment, the common event detection rule 400 is an if-then rule where the system will warn a driver if the real-time data received indicates the driver is both “at a highway entrance” 402A and “if the car is going a wrong direction” 402B. If both of these rules are met (e.g., based on vehicle position data, mapping data, etc.), the system will “send a message to the vehicle” 404 (e.g., perform an action) warning the driver they are traveling in the wrong direction on a highway entrance. This event detection rule 400 is common to all drivers of the vehicle and does not incorporate contextual data that may be available to modify the rule.

FIG. 4B illustrates an example extended rule 408 incorporated into a common event detection rule 400, in accordance with embodiments of the present disclosure. In embodiments, the extended rule 408 is an alternative rule that is configured to perform an action if the alternative rule/threshold is met. The extended rule 408 may be generated by the system based on an evaluation of contextual data received from one or more devices that are communicatively coupled to the vehicle. In the illustrated embodiment, the extended rule 408 modifies the event detection rule 400 by including alternative language that allows the system to “send a message to the vehicle” 404 if the vehicle is determined to be “at a highway entrance” 402 and “if the car is going a wrong direction” 402B “or if the driver ID is 012345” 402C. The extended rule 408 allows the common event detection rule 400 to be modified by utilizing available contextual information.

For example, a driver that has a behavioral driving history of traveling in the wrong direction at highway ramps may be warned, regardless of whether they are traveling in the wrong direction, that they are at a highway exit/entry ramp and to proceed in a certain direction to avoid traveling in the wrong direction. The extended rule allows the system to determine additional or alternative rules for each driver and/or vehicle depending on the contextual data. This allows the vehicle monitoring system 102 to apply the rules narrowly based on the driver and/or the vehicle.

Referring now to FIG. 5, shown is a high-level block diagram of an example computer system 1101 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 1101 may comprise one or more CPUs 1102, a memory subsystem 1104, a terminal interface 1112, a storage interface 1116, an I/O (Input/Output) device interface 1114, and a network interface 1118, all of which may be communicatively coupled, directly or indirectly, for inter-component communication via a memory bus 1103, an I/O bus 1108, and an I/O bus interface unit 1110.

The computer system 1101 may contain one or more general-purpose programmable central processing units (CPUs) 1102A, 1102B, 1102C, and 1102D, herein generically referred to as the CPU 1102. In some embodiments, the computer system 1101 may contain multiple processors typical of a relatively large system; however, in other embodiments the computer system 1101 may alternatively be a single CPU system. Each CPU 1102 may execute instructions stored in the memory subsystem 1104 and may include one or more levels of on-board cache. In some embodiments, a processor can include at least one or more of, a memory controller, and/or storage controller. In some embodiments, the CPU can execute the processes included herein (e.g., process 200 and 300).

System memory 1104 may include computer system readable media in the form of volatile memory, such as random-access memory (RAM) 1122 or cache memory 1124.

Computer system 1101 may further include other removable/non-removable, volatile/non-volatile computer system data storage media. By way of example only, storage system 1126 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 1104 can include flash memory, e.g., a flash memory stick drive or a flash drive. Memory devices can be connected to memory bus 1103 by one or more data media interfaces. The memory 1104 may include at least one program product having a set (e.g., at least one) of program modules that are configured to carry out the functions of various embodiments.

Although the memory bus 1103 is shown in FIG. 5 as a single bus structure providing a direct communication path among the CPUs 1102, the memory subsystem 1104, and the I/O bus interface 1110, the memory bus 1103 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 1110 and the I/O bus 1108 are shown as single units, the computer system 1101 may, in some embodiments, contain multiple I/O bus interface units 1110, multiple I/O buses 1108, or both. Further, while multiple I/O interface units are shown, which separate the I/O bus 1108 from various communications paths running to the various I/O devices, in other embodiments some or all of the I/O devices may be connected directly to one or more system I/O buses.

In some embodiments, the computer system 1101 may be a multi-user mainframe computer system, a single-user system, or a server computer or similar device that has little or no direct user interface, but receives requests from other computer systems (clients). Further, in some embodiments, the computer system 1101 may be implemented as a desktop computer, portable computer, laptop or notebook computer, tablet computer, pocket computer, telephone, smart phone, network switches or routers, or any other appropriate type of electronic device.

It is noted that FIG. 5 is intended to depict the representative major components of an exemplary computer system 1101. In some embodiments, however, individual components may have greater or lesser complexity than as represented in FIG. 5, components other than or in addition to those shown in FIG. 5 may be present, and the number, type, and configuration of such components may vary.

One or more programs/utilities 1128, each having at least one set of program modules 1130 may be stored in memory 1104. The programs/utilities 1128 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 1128 and/or program modules 1130 generally perform the functions or methodologies of various embodiments.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktops 96.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving real-time data from one or more internet of things (IoT) devices that are communicatively coupled to a vehicle;
analyzing the real-time data by applying one or more event detection rules;
determining the one or more event detection rules have not been met;
extracting contextual data from the real-time data;
correlating the contextual data with the one or more event detection rules;
generating, in response to the correlating, one or more extended rules incorporating the contextual data; and
applying the one or more extended rules to the real-time data.

2. The computer-implemented method of claim 1, further comprising:
determining the one or more extended rules have been met; and
performing an action in response to determining that the one or more extended rules have been met.

3. The computer-implemented method of claim 2, wherein the action is selected from the group consisting of:
deactivating one or more systems of the vehicle;
activating one or more systems of the vehicle;
displaying a notification on a vehicle device; and
sending a notification to the one or more IoT devices.

4. The computer-implemented method of claim 2, wherein determining the one or more extended rules have been met comprises:
comparing the real-time data to an extended rule data threshold.

5. The computer-implemented method of claim 1, wherein the contextual data is selected from the group consisting of vehicle sensor data, imaging data, user data, driving behavioral data, temporal data, vehicle data received from one or more other vehicles, road condition data, and weather data.

6. The computer-implemented method of claim 1, wherein the contextual data includes road condition data and weather data, wherein the road condition data and the weather data are received from an internet service.

7. The computer-implemented method of claim 1, wherein the contextual data includes biometric data received from one or more user devices communicatively coupled to a vehicle device.

8. The computer-implemented method of claim 1, wherein the contextual data includes imaging data generated by a communicatively coupled camera disposed on the vehicle.

9. The computer-implemented method of claim 1, wherein determining the one or more event detection rules have not been met further comprises:
analyzing a rule execution log relative to the vehicle.

10. A system comprising:
a processor; and
a computer-readable storage medium communicatively coupled to the processor and storing program instructions which, when executed by the processor, cause the processor to perform a method comprising:
receiving real-time data from one or more internet of things (IoT) devices that are communicatively coupled to a vehicle;
analyzing the real-time data by applying one or more event detection rules;
determining the one or more event detection rules have not been met;
extracting contextual data from the real-time data;
correlating the contextual data with the one or more event detection rules;
generating, in response to the correlating, one or more extended rules incorporating the contextual data; and
applying the one or more extended rules to the real-time data.

11. The system of claim 10, wherein the method performed by the processor further comprises:
determining the one or more extended rules have been met; and
performing an action in response to determining that the one or more extended rules have been met.

12. The system of claim 11, wherein the action is selected from the group consisting of:
deactivating one or more systems of the vehicle;
activating one or more systems of the vehicle;
displaying a notification on a vehicle device; and
sending a notification to the one or more IoT devices.

13. The system of claim 11, wherein determining the one or more extended rules has been met comprises:
comparing the real-time data to an extended rule data threshold.

14. The system of claim 10, wherein the contextual data is selected from the group consisting of vehicle sensor data, imaging data, user data, driving behavioral data, temporal data, vehicle data received from one or more other vehicles, road condition data, and weather data.

15. A computer program product comprising a computer-readable storage medium having program instructions embodied therewith, wherein the computer-readable storage medium is not a transitory signal per se, the program instructions executable by a processor to cause the processor to perform a method comprising:
receiving real-time data from one or more internet of things (IoT) devices that are communicatively coupled to a vehicle;
extracting contextual data from the real-time data;
correlating the contextual data with one or more event detection rules;
generating, in response to the correlating, one or more extended rules incorporating the contextual data; and
applying the one or more extended rules to the real-time data.

16. The computer program product of claim 15, wherein the method performed by the processor further comprises:
analyzing the real-time data by applying one or more event detection rules; and
determining the one or more event detection rules have not been met.

17. The computer program product of claim 15, wherein the method performed by the processor further comprises:
determining the one or more extended rules have been met; and
performing an action in response to determining that the one or more extended rules have been met.

18. The computer program product of claim 17, wherein the action is selected from the group consisting of:
deactivating one or more systems of the vehicle;
activating one or more systems of the vehicle;
displaying a notification on a vehicle device; and
sending a notification to the one or more IoT devices.

19. The computer program product of claim 17, wherein determining the one or more extended rules has been met comprises:
comparing the real-time data to an extended rule data threshold.

20. The computer program product of claim 15, wherein the contextual data is selected from the group consisting of vehicle sensor data, imaging data, user data, driving behavioral data, temporal data, vehicle data received from one or more other vehicles, road condition data, and weather data.
